(19) United States
(12) Patent Application Publication
(10) Pub. No.: US 2026/0208822 A1
(43) Pub. Date: Jul. 23, 2026

(54) E-BIKE MID-DRIVE MOTOR WITH BELT-DRIVEN TRANSMISSION

(71) Applicant: Gates Corporation, Denver, CO (US)

(72) Inventors: Brian Graichen, Leonard, MI (US); David Crowther, Bloomfield Hills, MI (US)

(73) Assignee: Gates Corporation, Denver, CO (US)

(21) Appl. No.: 19/141,258

(22) PCT Filed: Dec. 19, 2023
(86) PCT No.: PCT/US2023/084906

§ 371 Date: Jun. 19, 2025

Related U.S. Application Data
(60) Provisional application No. 63/433,546, filed on Dec. 19, 2022.

(51) Int. Cl. B62M 9/04; B62M 6/50; B62M 6/60; B62M 11/06

(52) U.S. Cl. CPC B62M 9/04; B62M 6/50; B62M 6/60; B62M 11/06

(57) ABSTRACT

A transmission for an electric motor-assisted vehicle translates the relatively high speed, low torque rotation of an output shaft of an electric motor to a drive wheel of the vehicle, the drive wheel turns a chain, a rear hub, and a rear wheel to propel the bicycle or other vehicle. The output shaft of the electric motor is offset from the crankshaft, and a plurality of belts transmits power from the electric motor to the drive wheel while decreasing rotational speed and increasing torque. In some embodiments, three belts and three wheels transmit power from the electric motor to the drive wheel. Various sensors and devices can transmit input signals to a controller that determines when and how the electric motor powers the transmission to assist the vehicle, which means less effort for a user if the vehicle is a bicycle being ridden by the user.

### CROSS-REFERENCE TO RELATED APPLICATIONS

This application claims priority to U.S. Provisional Patent Application Ser. No. 63/433,546 filed Dec. 19, 2022, which is incorporated herein in its entirety by reference.

### FIELD OF THE INVENTION

The disclosure relates to a transmission, in particular for an electric bicycle or “e-bike,” that converts power from an electric motor to an output using a plurality of belts.

### BACKGROUND OF THE INVENTION

E-bikes and other vehicles assisted by electric motors have enjoyed a recent surge in popularity, and cities such as Denver, Colorado have introduced rebate programs to encourage the adoption of e-bikes. E-bikes have an electric motor that selectively assists a user by supplying additional power to the bike under certain conditions like ascending a steep hill. Some e-bikes have pedal assist mode where the motor provides power to the bike in conjunction with the user providing power to the e-bike by pedaling. Some e-bikes have a motor that can power the bike without any assistance or pedaling by the rider, similar to a moped. Some e-bikes also have a sensor that detects an increased amount of effort on the part of the user, which may correspond to ascending a hill, and then the electric motor supplies additional power to the bike based on what the sensor detects. As a result, e-bikes provide users with improved fitness because the rider is pedaling, at least some of the time, instead of driving a car and sitting. E-bikes also improve the environment, particularly in comparison to gas-powered automobiles, as e-bikes do not produce gaseous emissions. In addition, e-bikes open the world of biking to a wider group of potential users, including users who may not have the physical ability to operate a traditional bicycle without an electric motor, riders who want to ride to work in business clothes and not arrive to work dirty or sweating, and riders who have to carry an additional load such as food delivery, groceries, work supplies, or children.

Various technologies, including a transmission, make possible the inclusion of an electric motor on a bicycle. Electric motors are most efficient when rotating an output shaft at relatively higher speeds with lower torque. Conversely, for locomotion of a bicycle, the tires and crankshaft that a user pedals rotate at relatively lower speeds with higher torque. Thus, a transmission can interface the electric motor with the bicycle and convert higher speed/lower torque to lower speed/higher torque. Existing gear trains use one or more gears, including spur gears or helical gears in, for instance, a planetary gear arrangement to transmit power from the electric motor.

There are several disadvantages with existing gear trains that use gears to transmit power, especially for electric motors and/or e-bikes. Existing gear trains add weight because the gears are typically solid metal, and the gears require lubrication since at least two gears contact each other at a metal-metal interface. Gears, in particular spur gears, also produce a lot of noise, which can be undesirable for a bicycle. Moreover, metal gears will wear over time, and thus require periodic, preventative maintenance to prevent failure. As described herein, embodiments of the present disclosure provide a transmission that relies on a plurality of belts to transmit power rather than metal gears. As such, the transmission is lighter, quieter, and requires no lubrication with relatively little or no maintenance.

### SUMMARY OF THE INVENTION

Embodiments of the present disclosure relate to a transmission that transmits power from an electric motor to a drive wheel of a bicycle such that the drive wheel rotates slower and with more torque than the electric motor to reduce the effort required by the user. It will be appreciated that the present disclosure encompasses embodiments where the transmission does not include components such as an electric motor and/or a controller. Moreover, the transmission typically does not include the crankshaft or drive wheel of the vehicle, specifically a bicycle in some embodiments, but the transmission may include such components in some embodiments.

It is one aspect of various embodiments of the present disclosure to provide a transmission where an electric motor is offset from a crankshaft to keep the transmission compact in a width direction for use in a bicycle or e-bike. The transmission can be located at the bottom bracket of a bicycle frame to operate with the crankshaft. Pedals are connected to crank arms, which are connected to the crankshaft, and a user engages the pedals to propel the bicycle. Thus, the transmission must accommodate the pedaling motion of the user. Moreover, the transmission must maintain a certain clearance over the ground surface to avoid contacting the surface while the user is riding the bicycle. With these constraints in mind, the electric motor is offset from the crankshaft to maintain a compact width between a first end and a second end of the crankshaft. In some embodiments, the electric motor has a width and position in the transmission such that the electric motor is positioned completely within the first and second ends of the crankshaft in the width direction. The distance between the ends of the crankshaft is similar to a Q-Factor of a bicycle, which is the distance between the outside of the pedal hole of the left crank arm and the outside of the pedal hole of the right crank arm, though the geometry of the crank arms can result in a difference between the ends of the crankshaft and the Q-Factor. Q-Factors vary with different types of bicycles, but a narrower Q-Factor is generally preferrable for improved aerodynamics, better handling, and a more natural pedaling motion. Thus, the distance between ends of the crankshaft is generally narrower, and the width of the electric motor is positioned between the ends of the crankshaft to accommodate the operation of the crankshaft and the form factor of the transmission. It is another aspect of various embodiments of the present disclosure to provide a transmission with a plurality of belts that transmits power from the electric motor to a drive wheel such that the drive wheel rotates slower and with more torque than the output shaft of the electric motor. In comparison to traditional gears, belts are cleaner, quieter, and require less maintenance. Since the electric motor is offset from the crankshaft, and the drive wheel is positioned about the crankshaft, there is an odd number of belts between an output shaft of the electric motor and the drive wheel. Based on the physical constraints and a desired overall gear ratio, the transmission has three belts in a preferred embodiment. However, the transmission can have any other number of belts in other embodiments.

It is a further aspect of embodiments of the present disclosure to provide a transmission with a controller and related components to control the transmission and assist the effort of a user, meaning reduce the energy input required by the user. The electric motor selectively powers the plurality of belts and the drive wheel, and a controller determines when and how much power the electric motor provides. Several different possible input devices transmit one or more input signals to the controller. For example, a user can twist a throttle or enter an assist level on a shifter or button. Alternatively or additionally, a torque sensor that detects an amount of user effort applied to the crankshaft can transmit an input signal to the controller. The controller determines a subsequent action based on these input signals. The subsequent action can include allowing a battery to supply electric power to the electric motor. The controller can also dictate a constant amperage, a varying amperage, or another manner of supplying the electric motor with amperage, which then powers the plurality of belts and the drive wheel.

It is another aspect of embodiments of the present disclosure to provide a transmission where an electric motor is associated with a bevel gear that contributes to the overall gear ratio of the transmission. In some embodiments, the electric motor is an axial flux motor that has an interior volume due to how the axial flux motor and its components convert electric power to physical motion. A bevel gear can be positioned in this interior volume to keep the transmission compact and to contribute to the overall gear ratio of the transmission.

Advantages of the belt-driven center drive transmission described in various embodiments herein is that it: (1) is best suited to integrate with an axial motor design, (2) is best suited for performance, (3) allows using bike existing geartrain technology, which has more power and/or torque, and (4) can integrate pulleys and belts.

A first aspect of the present disclosure is to provide a transmission for an electric motor-assisted vehicle, comprising a crankshaft rotatable about a crank axis, wherein the crankshaft is configured to power a drive wheel to propel the vehicle; an electric motor having an output shaft rotatable about a motor axis that is offset from the crank axis; a first wheel rotatable about the crank axis, wherein the first wheel has a driven portion and a drive portion; a second wheel rotatable about a wheel axis that is offset from the crank axis, wherein the second wheel has a driven portion and a drive portion; a third wheel rotatable about the crank axis, wherein the third wheel has a driven portion; a first belt engaged with the output shaft of the electric motor and engaged with the driven portion of the first wheel, wherein the first wheel is configured to rotate slower and with more torque than the output shaft of the electric motor; a second belt engaged with the drive portion of the first wheel and engaged with the driven portion of the second wheel, wherein the second wheel is configured to rotate slower and with more torque than the first wheel; and a third belt engaged with the drive portion of the second wheel and engaged with the driven portion of the third wheel, wherein the third wheel is configured to rotate slower and with more torque than the second wheel, and wherein the third wheel is configured to power the drive wheel to propel the vehicle.

The transmission of the first aspect may include, optionally, that the output shaft of the electric motor has a motor sprocket to which the first belt is engaged, and wherein the motor sprocket has between 16 and 20 teeth, and the driven portion of the first wheel has between 58 and 66 teeth for a first gear ratio between approximately 2.90:1 and 4.13:1.

The transmission of the first aspect may include one or more of the previous embodiments and, optionally, that the drive portion of the first wheel has between 28 and 32 teeth, and the driven portion of the second wheel has between 58 and 66 teeth for a second gear ratio of between approximately 1.81:1 and 2.36:1.

The transmission of the first aspect may include one or more of the previous embodiments and, optionally, that the drive portion of the second wheel has between 20 and 24 teeth, and the driven portion of the third wheel has between 58 and 66 teeth for a third gear ratio of between approximately 2.42:1 and 3.30:1.

The transmission of the first aspect may include one or more of the previous embodiments and, optionally, that the output shaft of the electric motor has a motor sprocket to which the first belt is engaged, and wherein the motor sprocket has between 17 and 21 teeth, and the driven portion of the first wheel has between 115 and 125 teeth for a first gear ratio between approximately 5.48:1 and 7.35:1.

The transmission of the first aspect may include one or more of the previous embodiments and, optionally, that the drive portion of the first wheel has between 26 and teeth, and the driven portion of the second wheel has between 68 and 72 teeth for a second gear ratio of between approximately 2.27:1 and 2.77:1.

The transmission of the first aspect may include one or more of the previous embodiments and, optionally, that the drive portion of the second wheel has between 26 and 30 teeth, and the driven portion of the third wheel has between 68 and 72 teeth for a third gear ratio of between approximately 2.27:1 and 2.77:1.

The transmission of the first aspect may include one or more of the previous embodiments and, optionally, that the first belt is between approximately 7 and 11 mm wide, the second belt is between approximately 6 and 10 mm wide, and the third belt is between approximately 16 and 20 mm wide.

The transmission of the first aspect may include one or more of the previous embodiments and, optionally, that the first belt is approximately 9 mm wide, the second belt is approximately 8 mm wide, and the third belt is approximately 18 mm wide.

The transmission of the first aspect may include one or more of the previous embodiments and, optionally, that the first belt is a PowerGrip® GT®3 3 mm belt, the second belt is a Poly Chain® GTR Carbon 5 mm belt, and the third belt is a Poly Chain® GT® Carbon 5 mm belt.

The transmission of the first aspect may include one or more of the previous embodiments and, optionally, a controller in communication with the electric motor, wherein the controller is configured to receive an input signal, and the controller is configured to cause the electric motor to transmit power to the drive wheel.

The transmission of the first aspect may include one or more of the previous embodiments and, optionally, that the crank axis, the motor axis, and the wheel axis are parallel to each other.

The transmission of the first aspect may include one or more of the previous embodiments and, optionally, that the first wheel and the third wheel are positioned about the crankshaft, and the third wheel is positioned between the first wheel and the drive wheel.

A second aspect of the present disclosure is to provide a transmission for an electric motor-assisted vehicle, the transmission having a crankshaft rotatable about a crank axis, wherein the crankshaft is configured to power a drive wheel on the vehicle to propel the vehicle, the transmission further comprising an electric motor having an output shaft rotatable about a motor axis that is offset from the crank axis; a plurality of belts that transmits power from the output shaft of the electric motor to the drive wheel of the vehicle, wherein the output shaft of the electric motor is configured to rotate faster and with less torque than the drive wheel; and a controller in communication with the electric motor, wherein the controller is configured to receive an input signal, and the controller is configured to cause the electric motor to transmit power through only the plurality of belts to the drive wheel.

The transmission of the second aspect may include, optionally, a first wheel rotatable about the crank axis, wherein the first wheel has a driven portion and a drive portion; a second wheel rotatable about a wheel axis that is offset from the crank axis, wherein the second wheel has a driven portion and a drive portion; a third wheel rotatable about the crank axis, wherein the third wheel has a driven portion; a first belt of the plurality of belts that is engaged with the output shaft of the electric motor and engaged with the driven portion of the first wheel, wherein the first wheel is configured to rotate slower and with more torque than the output shaft of the electric motor; a second belt of the plurality of belts that is engaged with the drive portion of the first wheel and engaged with the driven portion of the second wheel, wherein the second wheel is configured to rotate slower and with more torque than the first wheel; and a third belt of the plurality of belts that is engaged with the drive portion of the second wheel and engaged with the driven portion of the third wheel, wherein the third wheel is configured to rotate slower and with more torque than the second wheel, and wherein the third wheel is configured to engage with the drive wheel to power the drive wheel.

The transmission of the second aspect may include one or more of the previous embodiments and, optionally, that the electric motor is an axial flux motor that comprises a stator and a rotor that is rotatable relative to the stator; and a bevel gear engaged with the output shaft of the axial flux motor and engaged with the rotor such that the output shaft is configured to rotate slower and with more torque than the rotor.

The transmission of the second aspect may include one or more of the previous embodiments and, optionally, an input device in communication with the controller and configured to receive a user action, wherein the input device is configured to transmit the input signal to the controller, and the input device is one of a throttle, a shifter, or a button.

The transmission of the second aspect may include one or more of the previous embodiments and, optionally, a torque sensor engaged with the crankshaft and configured to detect a torque applied to the crankshaft, wherein the torque sensor is configured to transmit the input signal to the controller.

The transmission of the second aspect may include one or more of the previous embodiments and, optionally, a battery in communication with the controller, wherein the controller is configured to cause the battery to transmit electric power to the electric motor.

The transmission of the second aspect may include one or more of the previous embodiments and, optionally, that the controller is configured to cause the battery to transmit electric power with one of a constant amperage or a varying amperage.

A third aspect of the present disclosure is to provide a transmission for an electric motor-assisted vehicle, the transmission having a crankshaft rotatable about a crank axis, wherein the crankshaft is configured to propel the vehicle, the transmission further comprising an electric motor having an output shaft rotatable about a motor axis that is offset from the crank axis, wherein the electric motor comprises a stator and a rotor that is rotatable relative to the stator; a bevel gear engaged with the rotor and engaged with the output shaft of the electric motor such that the output shaft is configured to rotate slower and with more torque than the rotor; and a plurality of belts that transmits power from the output shaft of the electric motor to an output wheel, wherein the output shaft of the electric motor is configured to rotate faster and with less torque than the output wheel, and the electric motor is configured to transmit power through only the plurality of belts to the output wheel.

The transmission of the third aspect may include, optionally, a first wheel rotatable about the crank axis, wherein the first wheel has a driven portion and a drive portion; a second wheel rotatable about a wheel axis that is offset from the crank axis, wherein the second wheel has a driven portion and a drive portion; a third wheel rotatable about the crank axis, wherein the third wheel has a driven portion and the third wheel is the output wheel; a first belt of the plurality of belts that is engaged with the output shaft of the electric motor and engaged with the driven portion of the first wheel, wherein the first wheel is configured to rotate slower and with more torque than the output shaft of the electric motor; a second belt of the plurality of belts that is engaged with the drive portion of the first wheel and engaged with the driven portion of the second wheel, wherein the second wheel is configured to rotate slower and with more torque than the first wheel; and a third belt of the plurality of belts that is engaged with the drive portion of the second wheel and engaged with the driven portion of the third wheel, wherein the third wheel is configured to rotate slower and with more torque than the second wheel, and wherein the third wheel is configured to propel the vehicle.

The transmission of the third aspect may include one or more of the previous embodiments and, optionally, that the electric motor is an axial flux motor, and inner surfaces of the stator and the rotor define an interior volume in which the bevel gear is positioned.

The transmission of the third aspect may include one or more of the previous embodiments and, optionally, that the crankshaft extends between a first end and a second end along the crank axis, and the axial flux motor has a width dimension positioned within the first and second ends along the crank axis.

The transmission of the third aspect may include one or more of the previous embodiments and, optionally, that the bevel gear provides a gear ratio of approximately 2:1, and the bevel gear rotates about an axis that is perpendicular to the motor axis.

The transmission of the third aspect may include one or more of the previous embodiments and, optionally, a controller in communication with the electric motor; and a battery in communication with the controller, wherein the controller is configured to receive an input signal, and the controller is configured to cause the battery to transmit electric power to the electric motor.

The phrases “at least one”, “one or more”, and “and/or”, as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

It is to be appreciated that any feature or aspect described herein can be claimed in combination with any other feature(s) or aspect(s) as described herein, regardless of whether the features or aspects come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1 is a side elevation view of part of a bicycle with a transmission in accordance with an embodiment of the present disclosure;

FIG. 2A is a perspective view of the transmission of FIG. 1 without a housing shown in accordance with an embodiment of the present disclosure;

FIG. 2B is a top plan view of the transmission in FIG. 2A in accordance with an embodiment of the present disclosure;

FIG. 3A is an exploded view of the transmission in FIG. 1 in accordance with an embodiment of the present disclosure;

FIG. 3B is a top plan, cross-sectional view of an axial flux motor taken along line B-B in FIG. 3A in accordance with an embodiment of the present disclosure; and

FIG. 4 is a schematic view of a controller and other components in accordance with an embodiment of the present disclosure.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

| | |
|---|---|
| 2 | Bicycle |
| 4 | Crankshaft |
| 6 | Pedal |
| 8 | Drive Wheel |
| 10 | Chain |
| 12 | Rear Hub |
| 14 | Rear Wheel |
| 16 | Transmission |
| 18 | Crank Axis |
| 20 | First End |
| 22 | Second End |
| 24 | Electric Motor |
| 26 | Output Shaft |
| 28 | Motor Axis |
| 30 | First Wheel |
| 32 | First Belt |
| 34 | Second Wheel |
| 36 | Wheel Axis (of the Second Wheel) |
| 38 | Second Belt |
| 40 | Third Wheel |
| 42 | Third Belt |
| 44 | Controller |
| 46a, 46b | Housing |
| 48 | Motor Sprocket |
| 50 | Driven Portion of the First Wheel |
| 52 | Drive Portion of the First Wheel |
| 54 | First Belt Tensioner |
| 56 | Driven Portion of the Second Wheel |
| 58 | Drive Portion of the Second Wheel |
| 60 | Second Belt Tensioner |
| 62 | Torque Sensor |
| 64 | Driven Portion of the Third Wheel |
| 66 | Drive Portion of the Third Wheel |
| 68 | Third Belt Tensioner |
| 70 | Stator |
| 72 | Windings |
| 74 | Rotor |
| 76 | Interior Volume |
| 78 | Bevel Gear |
| 80 | Bevel Axis |
| 82 | Input |
| 84 | Battery |

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment of the transmission since describing every possible embodiment would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present invention. Thus, dimensions, aspects, and features of one embodiment of the transmission can be combined with dimensions, aspects, and features of another embodiment of the transmission to create the claimed embodiment.

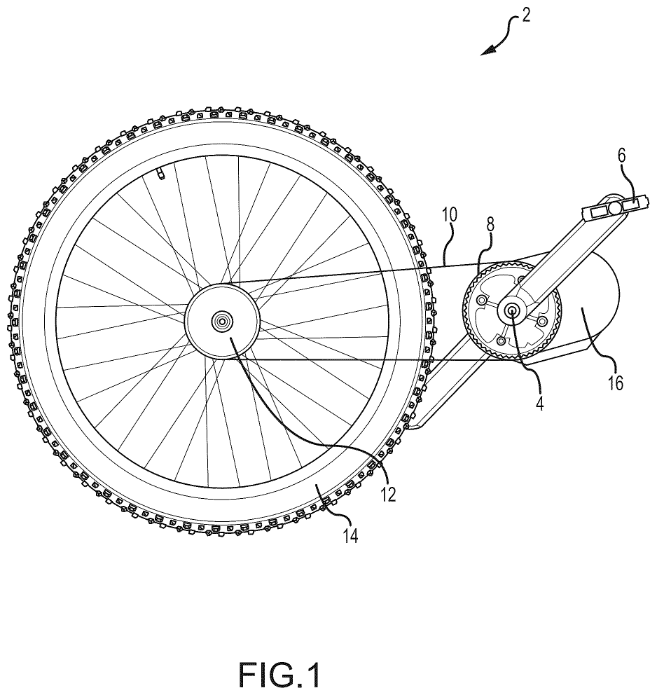

FIG. 1 shows a side elevation view of part of a bicycle 2 with a transmission 16 according to embodiments of the present disclosure. A user can engage pedals 6 to turn a crankshaft 4 and a drive wheel 8, which is a sprocket in this embodiment. Rotation of the drive wheel 8 turns a chain 10 that is engaged with a sprocket of a rear hub 12, and rotation of the rear hub 12 drives a rear wheel 14 to propel the bicycle 2. It will be appreciated that this transmission 16 can be used with bicycles that have multiple sprockets at the crankshaft 4 and/or the rear hub 12 as is found in some bicycles. In a preferred embodiment, the transmission 16 includes an electric motor (not visible in this view), but the electric motor can be positioned in different locations than shown here, including outside of the housing. Moreover, embodiments of the present disclosure can be used with other vehicles such as mopeds, golf carts, or any other small, electric powered vehicle that can benefit from a transmission 16 between two different rotational speeds.

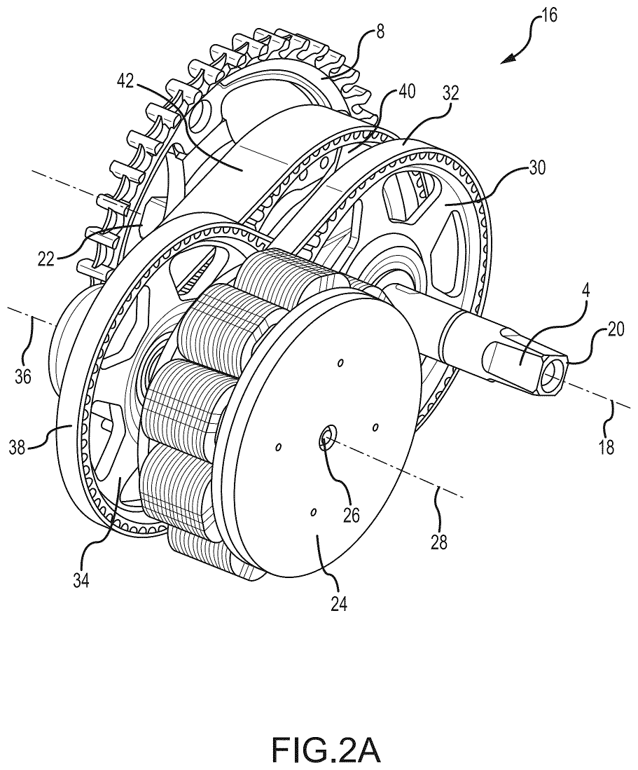

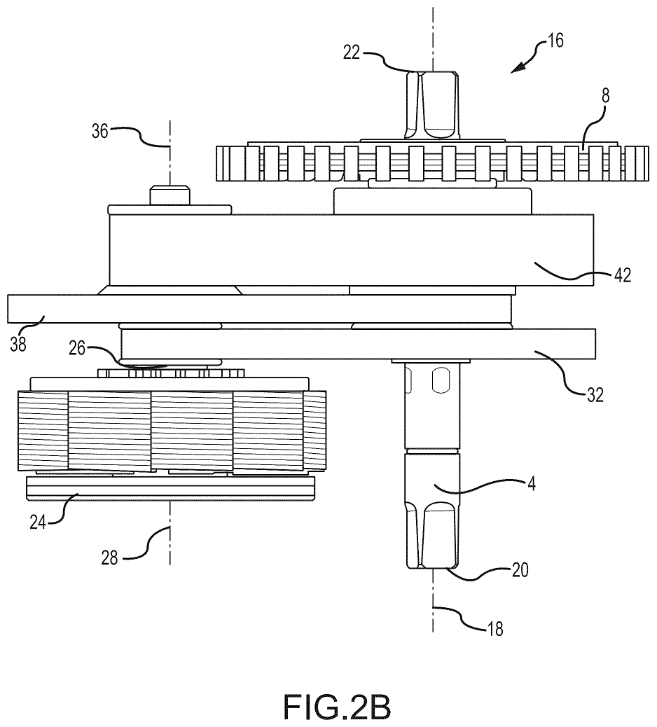

FIG. 2A shows the transmission 16 of FIG. 1 without a housing to show the various components within the transmission 16. In addition, FIG. 2B is a top plan view of the transmission of FIG. 2A. The crankshaft 4 is rotatable about a crank axis 18, and the crankshaft 4 extends between a first end 20 and a second end 22. The pedals turn the crankshaft 4 to turn the drive wheel 8 and propel the bicycle. Next, an electric motor 24 has an output shaft 26 that rotates about a motor axis 28, and the electric motor 24 is positioned between the first end 20 and the second end 22. As described herein, in some embodiments, the electric motor 24 is an axial flux motor to better complement the form factor of the transmission 16 for a bicycle. However, it will be appreciated that the present disclosure encompasses embodiments where the electric motor 24 is another type of motor such as a radial electric motor.

A first wheel 30 is positioned about the crankshaft 4 and is rotatable about the crank axis 18. A first belt 32 joins the output shaft 26 of the electric motor 24 with the first wheel 30, and the first wheel 30 rotates slower and with more torque than the output shaft 26. Then, a second belt 38 extends from another part of the first wheel 30 to a second wheel 34 that is rotatable about a wheel axis 36 that is offset from the crank axis 18. The axes 18, 28, 36 are parallel with each other, and in some embodiments, the motor axis 28 and the wheel axis 36 are coaxial. In other embodiments, the wheel axis 36 is offset from the motor axis 28. The second wheel 34 rotates slower and with more torque than the first wheel 30.

A third belt 42 extends from another part of the second wheel 34 to a third wheel that is positioned about the crankshaft 4 and rotatable about the crank axis 18. The third wheel 40 rotates slower and with more torque than the second wheel 34. Moreover, the third wheel 40 is engaged with the drive wheel 8 such that the third wheel 40 transmits power to the drive wheel 8 to propel the bicycle.

In some embodiments, the overall gear ratio of the transmission 16 from the electric motor 24 to the drive wheel 8 is approximately 40:1. In various embodiments, the overall gear ratio is between approximately 20:1 and 50:1. With the drive wheel 8 and crankshaft 4 rotatable about the crank axis 18 and the output shaft 26 of the electric motor 24 rotatable about a separate, motor axis 28, the number of belts must be an odd number of belts. Constrained by this aspect of the transmission 16 as well as the overall gear ratio and the form factor of the transmission 16, three belts 32, 38, 42 represents a preferred embodiment of the transmission 16. However, it will be appreciated that the present disclosure encompasses one, five, or any odd number of belts.

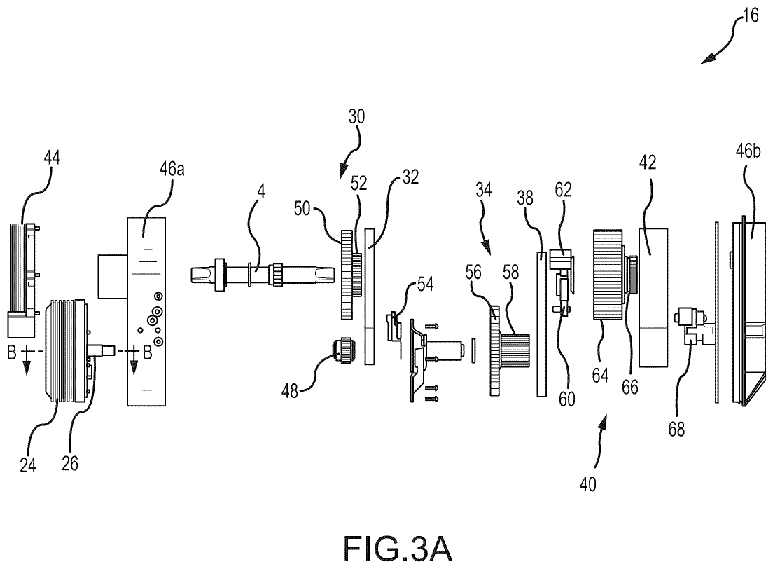

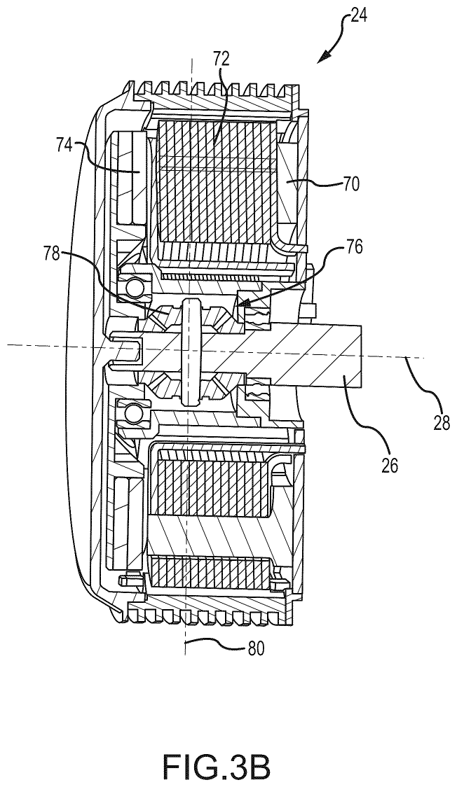

FIG. 3A shows an exploded view of the transmission 16. Two parts of a housing 46a, 46b combine to enclose many of the components of the transmission 16 while generally excluding the electric motor 24 and a controller 44. However, it will be appreciated that the present disclosure encompasses other configurations of the housing and components, including embodiments with the electric motor 24 and controller 44 positioned within the housing, as well as no housing where, for instance, the components of the transmission 16 are integrated into part of the vehicle itself. The term “transmission” can include only the housing 46a, 46b and the components disposed within the housing such as the crankshaft 4, while excluding components such as the drive wheel. In some embodiments, the transmission 16 includes the electric motor 24 and the controller 44, even though these components 24, 44 may be substantially positioned outside of the housing 46a, 46b. As described herein, some embodiments of the transmission 16 have three belts 32, 38, 42, which can have different characteristics such as width, thickness, and length.

In some embodiments, the first belt 32 is between approximately 7 and 11 mm wide, the second belt 38 is between approximately 7 and 11 mm wide, and the third belt 42 is between approximately 25 and 35 mm wide. In various embodiments, the first belt 32 is approximately 9 mm wide, the second belt 38 is approximately 9 mm wide, and the third belt 42 is approximately 30 mm wide. The third belt 42 is wider than either the first belt 32 or the second belt 38 to handle the larger torque transmitted and higher tensile load at this location in the transmission 16.

In various embodiments, the first belt 32 can have 78 teeth and pitch length of 390 mm, the second belt 38 can have 81 teeth and a pitch length of 405 mm, and the third belt 42 can have 78 teeth and a pitch length of 390 mm. Each belt 32, 38, 42 has alternating teeth and grooves; and the sprockets, driver portions, and driven portions have alternating teeth and grooves that mesh with the respective belts 32, 38, 42. In some embodiments, the first belt 32 is Poly Chain® GTR Carbon 5MGT belt, the second belt 38 is a Poly Chain® GTR Carbon 5MGT belt, and the third belt 42 is a Poly Chain® GT® Carbon 5MGT belt. These belts are made from a multilayer polyurethane, however, it will be appreciated that the present disclosure encompasses embodiments with different sizes and types of belts.

A motor sprocket 48 is connected to the output shaft 26 of the electric motor 24, and the first wheel 30 has a driven portion 50 and a drive portion 52. The driven portion 50 has a larger outer diameter than the drive portion 52. The first belt 32 joins the motor sprocket 48 and the driven portion 50 of the first wheel 30. In some embodiments, the motor sprocket 48 has between 16 and 20 teeth, and the driven portion 50 of the first wheel 30 has between 58 and 66 teeth for a first gear ratio between approximately 2.90:1 and 4.13:1. In various embodiments, the motor sprocket 48 has 18 teeth, and the driven portion 50 of the first wheel 30 has 62 teeth for a first gear ratio of approximately 3.4:1.

The second wheel 34 has a driven portion 56 and a drive portion 58, and the second wheel 34 can rotate about a projection or hub connected to the housing 46a, 46b. The outer diameter of the driven portion 56 is larger than the outer diameter of the drive portion 58. The second belt 38 joins the drive portion 52 of the first wheel 30 with the driven portion 56 of the second wheel 34. In some embodiments, the drive portion 52 of the first wheel 30 has between 28 and 32 teeth, and the driven portion 56 of the second wheel 34 has between 58 and 66 teeth for a second gear ratio of between approximately 1.81:1 and 2.36:1. In various embodiments, the drive portion 52 of the first wheel 30 has teeth, and the driven portion 56 of the second wheel 34 has 62 teeth for a second gear ratio of approximately 2.1:1.

The third wheel 40 has a driven portion 64 and a drive portion 66. The driven portion 64 has a larger outer diameter than the outer diameter of the drive portion 66. The third belt 42 joins the drive portion 58 of the second wheel 34 with the driven portion 64 of the third wheel 40. In some embodiments, the drive portion 58 of the second wheel 34 has between 20 and 24 teeth, and the driven portion 64 of the third wheel 40 has between 58 and 66 teeth for a third gear ratio of between approximately 2.42:1 and 3.30:1. In various embodiments, the drive portion 58 of the second wheel 34 has 22 teeth, and the driven portion 64 of the third wheel 40 has 62 teeth for a third gear ratio of approximately 2.8:1. As noted above, a combination of the first, second, and third gear ratios as well as an optional bevel gear of the electric motor 24 results in the overall gear ratio.

Moreover, in this embodiment, the gear ratios are similar to each other to keep the overall size and shape of the transmission compact and to maintain the size of the driver portions of the wheels. With similar gear ratios, the size of the driven portions of the wheels are similar in size. As the largest driven portion dictates the size and shape of the transmission, having the driven portions similar in size optimizes the transmission to a more compact size and shape. In addition, if the driver portions of the wheels are too small, then the driver portions may not function as well or may slip relative to a belt due to fewer teeth contacting the belt. Thus, keeping the gear ratios similar to each other helps prevent a driver portion from becoming too small.

In the described embodiment, the first, second, and third gear ratios are approximately 3.4:1, 2.1:1, and 2.8:1, respectively. For an overall gear ratio of 20:1 evenly split among three separate gear ratios, then each gear ratio would be approximately 2.7:1. Therefore, it can be stated that the first, second, and third gear ratios of this embodiment are within +/−30% of the gear ratio of 2.7:1 to keep the form factor of the transmission compact. However, the present disclosure encompasses embodiments of the transmission with other arrangements. For instance, the overall gear ratio can be different (e.g., 30:1, 40:1, etc.) or the number of belts can be different (e.g., four, five six, etc.), but the gear ratios are similar to each other to keep the size of the transmission compact and to prevent the driver portions from becoming too small.

As described herein, the third wheel 40 is engaged with the drive wheel 8 to transmit power to the drive wheel 8 and propel the vehicle. Accordingly, in some embodiments, an outer surface of the drive portion 66 interfaces with an inner surface of the drive wheel 8 to transmit power. In various embodiments, the drive portion 66 of the third wheel 40 is the drive wheel 8 itself. Further still, the drive portion 66 can transmit power to an intermediate component such as a further belt, a collar, etc., which then transmits power to the drive wheel 8. For example, the drive portion 66 is a spline interface that connects to a chainring spider, which connects to, or is part of, the drive wheel 8.

FIG. 3A also shows a first belt tensioner 54 for the first belt 32, a second belt tensioner 60 for the second belt 38, and a third belt tensioner 68 for the third belt 42 to provide appropriate tension on the belts 32, 38, 42 during operation of the transmission 16.

Finally, FIG. 3A shows a torque sensor 62 that detects torque between the crankshaft 4 and the third wheel 40, which is engaged with the drive wheel. In this sense, the torque sensor 62 detects a torque applied by a user to the pedals and the crankshaft 4 relative to the third wheel 40 and the drive wheel. During operation, a user may apply little or no torque to the crankshaft 4 when coasting downhill, but the user may apply a large amount of torque to the crankshaft 4 when pedaling uphill, which can be an indication to the transmission 16 that the electric motor 24 should assist the effort of the user. As described herein, the torque sensor 62 can communicate with the controller 44 and the electric motor 24 to assist a user.

FIG. 3B shows a cross-section of the electric motor 24 taken along line B-B in FIG. 3A. In this embodiment, the electric motor 24 is an axial flux motor that has a stator 70, windings 72 to receive electric power, and a rotor 74 that rotates relative to the stator 70 once the windings 72 receive electric power. The rotation of the rotor 74 drives a bevel gear 78 about a bevel axis 80 that is perpendicular to the motor axis 28, which in turn drives the output shaft 26 of the electric motor 24 about a motor axis 28. The inclusion of the bevel gear 78 can add a further gear ratio to the overall transmission. In some embodiments, the bevel gear 78 adds a 2:1 gear ratio, which reduces the contributions of the wheels and belts to the overall gear ratio of the transmission and allows the other components of the transmission to be smaller and more compact. The bevel gear 78 is positionable about the output shaft 26 and within an interior volume 76 defined, at least in part, by the inner surfaces of the other components 70, 72, 74 of the electric motor 24, which in this embodiment is an axial flux motor 24. The axial flux motor 24 can have an interior volume 76 due to the arrangement of components of the axial flux motor to convert electric power to mechanical power. In an effort to keep the transmission compact and to contribute to the overall gear ratio of the transmission, this interior volume 76 is utilized with a bevel gear 78. It will be appreciated that the bevel gear can provide a gear ratio other than 2:1, and a gear other than a bevel gear can provide a gear ratio. Moreover, in some embodiments, the output shaft 26 is directly connected to a rotor 74 or is otherwise engaged with the rotor 74 without an intermediate gear.

The axial flux motor 24 can have several performance characteristics that make the axial flux motor 24 suitable for use in the described transmission. For instance, the output speed of the axial flux motor 24 may be approximately 2400 rpm and the output torque may be approximately 3 Nm. The power of the axial flux motor 24 can be approximately 753.6024 watts with a voltage of approximately 36 volts. The physical dimensions of the axial flux motor 24 can be approximately 90 mm in diameter and 31 mm in width. Other characteristics are summarized in Tables 1-5. It will be appreciated that the characteristics of the axial flux motor 24 described herein are only exemplary in nature.

TABLE 1 is a summary of the power rating of
an exemplary axial flux motor 24.

| Characteristic | Unit | Value |
|---|---|---|
| Power at Maximum Speed | kW | 0.75 |
| Speed | rpm | 2400 Nominal, |
| | | 5000 Maximum |
| Frequency | Hz | 40 (at 2400 rpm), |
| | | 83.3 (at 5000 rpm) |
| Applied voltage | V | 36 |
| Number of Poles | — | 12 |
| Number of Phases | — | 3 |
| Wiring Connection | — | Star |

TABLE 2 is a summary of the geometrical parameters
of an exemplary axial flux motor 24.

| Characteristic | Unit | Value |
|---|---|---|
| Air Gap Length | mm | 1 |
| Outer Diameter of Stator | mm | 90 |
| Inner Diameter of Stator | mm | 45 |
| Length of Stator Core | mm | 23 |
| Outer Diameter of Rotor | mm | 90 |
| Inner Diameter of Rotor | mm | 45 |
| Length of Rotor Core | mm | 3 |
| Magnet Embrace | — | 0.8 |
| Magnet Radian Length | mm | 22.5 |
| Magnet Axial Thickness | mm | 4 |
| Magnet Skew Width | deg | 0 |

TABLE 3 is a summary of the winding configuration
of an exemplary axial flux motor 24.

| Characteristic | Unit | Value |
|---|---|---|
| Winding Type | — | Nonoverlap-double layer |
| Coil Pitch | — | 1 |
| Winding Factor | — | 0.866025 |
| Number of Conductors | — | 30 |
| per Slot | | |
| Number of Wires | — | 1 |
| per Conductor | | |
| Wire Diameter | mm | 3.02775903 |
| Slot Fill Factor | % | 71.6 |

TABLE 4 is a summary of the material composition
of an exemplary axial flux motor 24.

| Characteristic | Unit | Value |
|---|---|---|
| Rotor Back Iron | — | Somaloy-hoganas-700HR-3p |
| Stator Back Iron | — | Somaloy-hoganas-700HR-3p |
| and Tooth | | |
| Permanent Magnet | — | Arnold_Magnetics_N45UH 120C |
| Residual Flux Density | tesla | 1.188 |
| of Magnet | | |
| Stator Wire Density | kg/m\hat{ }3 | 8933 |
| Stator Core Steel Density | kg/m\hat{ }3 | 7520 |
| Rotor Magnet Density | kg/m\hat{ }3 | 7500 |
| Rotor Core Steel Density | kg/m\hat{ }3 | 7520 |
| Stator Net Weight | kg | 1.07832 |
| Rotor Net Weight | kg | 0.343224 |

TABLE 5 is a summary of the optimal operating condition
of an exemplary axial flux motor 24.

| Characteristic | Unit | Value |
|---|---|---|
| Stator Resistance | Ohm | 0.0766396 |
| Leakage Inductance | H | 0.00123468 |
| Root-Mean-Square | A | 14.4613 |
| Armature Current | | |
| Iron-Core Loss | W | 10.4674 |
| Armature Copper Loss | W | 48.0824 |
| Total Loss | W | 73.5499 |
| Output Power | W | 750.095 |
| Input Power | W | 823.645 |
| Efficiency | % | 91.0702 |
| Speed | rpm | 2400 |
| Torque | Nm | 2.98453 |
| Fundamental RMS | V | 17.8226 |
| Phase Back-EMF | | |
| THD of Phase-Back EMF | % | 3.76355 |

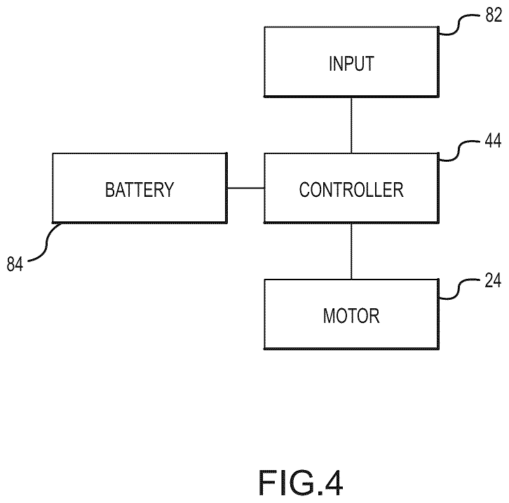

FIG. 4 shows a schematic view of the controller 44 and related components. The controller 44 coordinates various components to power the electric motor 24, which transmits power through the transmission to the drive wheel to assist a user riding a bike. As part of this coordination, the controller 44 can selectively allow a battery 84 to supply the electric motor 24 with electric power. The battery 84 can be part of, or integrated with, the transmission in some embodiments. In other embodiments, the battery 84 is separate from the transmission. For example, the transmission can be located at a bottom bracket of the frame of the bicycle, and the battery 84 can be located on the downtube of the frame and operatively connected to the controller of the transmission. It may be advantageous to have a removable battery 84, whether the battery 84 is integrated with the transmission or separate, since a user can take the battery 84 to another location for recharging such as a home, an office, etc. Various embodiments of the transmission can include a generator or other similar components for generating electricity to power the controller, recharge the battery 84, and other functions.

One or more input devices 82 can transmit one or more input signals to the controller 44 where the controller 44 can take further action, or not, based on the one or more input signals. A torque sensor that detects a torque applied to the crankshaft relative to the drive wheel can serve as an input device 82 to the controller 44. Raw information from the torque sensor can be transmitted to the controller 44 as an input signal, or the torque sensor itself can determine information such as a torque reading, speed data, etc., which is then transmitted to the controller 44 as the input signal. In one example, the controller 44 can determine if a torque reading is above a predetermined threshold, then the controller 44 permits a predetermined amount of electric power to flow from the battery 84 to the electric motor 24 to assist a user by supplying power to the drive wheel.

A user can engage other input devices 82 in communication with the controller 44. The input device 82 can be, for instance, an assist level selector like a shifter or a button, a throttle, etc. With a shifter like those commonly found on the handlebars of bicycles or a button, a user can select an assist level, which is then transmitted to the controller as an input signal. In one exemplary embodiment, the assist levels range from 0-10 with 0 being no assist from the electric motor and 10 being the most assist from the electric motor. Thus, when the assist level is selected as 10, the controller 44 permits a large amperage of current to flow to the electric motor 24 when the electric motor 24 is assisting the user. At an assist level of 9, the controller 44 permits less amperage and so forth until at the assist level of 0 the controller 44 permits no amperage of current to flow to the electric motor 24 such that there is no pedal assist for the user.

A button or shifter selection of assist level can be a selection of a discrete level of power assist, for instance, a number between 0-10, but the selection can also be among a potentially infinite number of power assist levels. The input device 82 can be a device where a user displaces a lever, a dial, a paddle, etc., and a sensor detects the amount of physical displacement and transmits an input signal to the controller 44. In this sense a twist throttle can also provide an input signal to the controller 44 among a potential infinite number of twist angles. The twist throttle can operate the transmission and bicycle even independent of any user engagement of the pedals and crankshaft.

Yet another possible input device 82 is a rain sensor that detects moisture and transmits an input signal to the controller 44. The controller 44 can determine when the moisture exceeds a predetermined threshold that corresponds to, for example, rain. Then, the controller 44 can take further action such as capping the amount of electric power that can flow from the battery 84 to the electric motor 24, or prevent any electrical power from flowing, to prevent excessive speed of the bicycle in rain conditions or damage to electric components.

Further still, another possible input device 82 is a speed sensor for the bicycle. As described herein, speed data can be derived from a torque sensor. Speed data can also be derived from a cadence sensor, a Global Positioning System (GPS) device, an accelerometer, etc. Speed data can be used in a number of ways, including limiting the speed of the bicycle as various countries have laws and rules governing the speed of an e-bike. A user can also establish a speed limit for the bicycle. The input devices 82 described herein are exemplary in nature and are not an exhaustive list of possible input devices 82.

Once the controller 44 receives one or more input signals, the controller 44 can determine how to operate the transmission. In one example, the user has engaged an input device 82 to select an assist level of 10 out of 10, and the input device 82 transmits a first input signal to the controller 44. Moreover, an input device 82 that is a torque sensor transmits a second input signal to the controller 44, and an input device 82 that is a moisture sensor transmits a third input signal to the controller 44. The controller 44 assess that the moisture reading is below a threshold level where excessive moisture would be dangerous, the torque reading is about a threshold level where the user needs assistance, and the assist level of 10 is associated with a predetermined amperage, and thus, based on these input signals, the controller 44 allows electric power to flow from the battery 84 to the electric motor 24 at the predetermined amperage to assist a user, but not so fast that speed data from a speed sensor exceeds a predetermined threshold established by a manufacturer to comply with a law or a rule or even by a user.

The controller 44 can also control the characteristics of the electric motor 24 as the electric motor 24 powers the transmission to assist a user. The electric motor 24 can rotate with a particular force, speed, momentum, acceleration, etc. The controller 44 can govern these characteristics by how the controller 44 controls the flow of electric power from the battery 84 to the electric motor 24. In some embodiments, the controller 44 may transmit an output signal to the electric motor 24 to govern these characteristics. Moreover, the controller 44 can provide a dynamic response to one or more inputs where the controller 44 varies the amperage over time. In some embodiments, the controller 44 holds an amperage over time.

While various embodiments of the present invention have been described in detail, it is apparent that modifications and alterations of those embodiments will occur to those skilled in the art. However, it is to be understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A transmission for an electric motor-assisted vehicle, comprising:
a crankshaft rotatable about a crank axis, wherein the crankshaft is configured to power a drive wheel to propel the vehicle;
an electric motor having an output shaft rotatable about a motor axis that is offset from the crank axis;
a first wheel rotatable about the crank axis, wherein the first wheel has a driven portion and a drive portion;
a second wheel rotatable about a wheel axis that is offset from the crank axis, wherein the second wheel has a driven portion and a drive portion;
a third wheel rotatable about the crank axis, wherein the third wheel has a driven portion;
a first belt engaged with the output shaft of the electric motor and engaged with the driven portion of the first wheel, wherein the first wheel is configured to rotate slower and with more torque than the output shaft of the electric motor;
a second belt engaged with the drive portion of the first wheel and engaged with the driven portion of the second wheel, wherein the second wheel is configured to rotate slower and with more torque than the first wheel; and
a third belt engaged with the drive portion of the second wheel and engaged with the driven portion of the third wheel, wherein the third wheel is configured to rotate slower and with more torque than the second wheel, and wherein the third wheel is configured to power the drive wheel to propel the vehicle.

2. The transmission of claim 1, wherein the output shaft of the electric motor has a motor sprocket to which the first belt is engaged, and wherein the motor sprocket has between 16 and 20 teeth, and the driven portion of the first wheel has between 58 and 66 teeth for a first gear ratio between approximately 2.90:1 and 4.13:1.

3. The transmission of claim 1, wherein the drive portion of the first wheel has between 28 and 32 teeth, and the driven portion of the second wheel has between 58 and 66 teeth for a second gear ratio of between approximately 1.81:1 and 2.36:1.

4. The transmission of claim 1, wherein the drive portion of the second wheel has between 20 and 24 teeth, and the driven portion of the third wheel has between 58 and 66 teeth for a third gear ratio of between approximately 2.42:1 and 3.30:1.

5. The transmission of claim 1, further comprising:
a controller in communication with the electric motor, wherein the controller is configured to receive an input signal, and the controller is configured to cause the electric motor to transmit power to the drive wheel.

6. The transmission of claim 1, wherein the crank axis, the motor axis, and the wheel axis are parallel to each other.

7. The transmission of claim 1, wherein the first wheel and the third wheel are positioned about the crankshaft, and the third wheel is positioned between the first wheel and the drive wheel.

8. A transmission for an electric motor-assisted vehicle, the transmission having a crankshaft rotatable about a crank axis, wherein the crankshaft is configured to power a drive wheel on the vehicle to propel the vehicle, the transmission further comprising:
an electric motor having an output shaft rotatable about a motor axis that is offset from the crank axis;
a plurality of belts that transmits power from the output shaft of the electric motor to the drive wheel of the vehicle, wherein the output shaft of the electric motor is configured to rotate faster and with less torque than the drive wheel; and
a controller in communication with the electric motor, wherein the controller is configured to receive an input signal, and the controller is configured to cause the electric motor to transmit power through only the plurality of belts to the drive wheel.

9. The transmission of claim 8, further comprising:
a first wheel rotatable about the crank axis, wherein the first wheel has a driven portion and a drive portion;
a second wheel rotatable about a wheel axis that is offset from the crank axis, wherein the second wheel has a driven portion and a drive portion;
a third wheel rotatable about the crank axis, wherein the third wheel has a driven portion;
a first belt of the plurality of belts that is engaged with the output shaft of the electric motor and engaged with the driven portion of the first wheel, wherein the first wheel is configured to rotate slower and with more torque than the output shaft of the electric motor;
a second belt of the plurality of belts that is engaged with the drive portion of the first wheel and engaged with the driven portion of the second wheel, wherein the second wheel is configured to rotate slower and with more torque than the first wheel; and
a third belt of the plurality of belts that is engaged with the drive portion of the second wheel and engaged with the driven portion of the third wheel, wherein the third wheel is configured to rotate slower and with more torque than the second wheel, and wherein the third wheel is configured to engage with the drive wheel to power the drive wheel.

10. The transmission of claim 8, wherein the electric motor is an axial flux motor that comprises:
a stator and a rotor that is rotatable relative to the stator; and
a bevel gear engaged with the output shaft of the axial flux motor and engaged with the rotor such that the output shaft is configured to rotate slower and with more torque than the rotor.

11. The transmission of claim 8, further comprising:
an input device in communication with the controller and configured to receive a user action, wherein the input device is configured to transmit the input signal to the controller, and the input device is one of a throttle, a shifter, or a button.

12. The transmission of claim 8, further comprising:
a torque sensor engaged with the crankshaft and configured to detect a torque applied to the crankshaft, wherein the torque sensor is configured to transmit the input signal to the controller.

13. The transmission of claim 8, further comprising:
a battery in communication with the controller, wherein the controller is configured to cause the battery to transmit electric power to the electric motor.

14. The transmission of claim 13, wherein the controller is configured to cause the battery to transmit electric power with one of a constant amperage or a varying amperage.

15. A transmission for an electric motor-assisted vehicle, the transmission having a crankshaft rotatable about a crank axis, wherein the crankshaft is configured to propel the vehicle, the transmission further comprising:
an electric motor having an output shaft rotatable about a motor axis that is offset from the crank axis, wherein the electric motor comprises a stator and a rotor that is rotatable relative to the stator;
a bevel gear engaged with the rotor and engaged with the output shaft of the electric motor such that the output shaft is configured to rotate slower and with more torque than the rotor; and
a plurality of belts that transmits power from the output shaft of the electric motor to an output wheel, wherein the output shaft of the electric motor is configured to rotate faster and with less torque than the output wheel, and the electric motor is configured to transmit power through only the plurality of belts to the output wheel.

16. The transmission of claim 15, further comprising:
a first wheel rotatable about the crank axis, wherein the first wheel has a driven portion and a drive portion;
a second wheel rotatable about a wheel axis that is offset from the crank axis, wherein the second wheel has a driven portion and a drive portion;
a third wheel rotatable about the crank axis, wherein the third wheel has a driven portion and the third wheel is the output wheel;
a first belt of the plurality of belts that is engaged with the output shaft of the electric motor and engaged with the driven portion of the first wheel, wherein the first wheel is configured to rotate slower and with more torque than the output shaft of the electric motor;
a second belt of the plurality of belts that is engaged with the drive portion of the first wheel and engaged with the driven portion of the second wheel, wherein the second wheel is configured to rotate slower and with more torque than the first wheel; and
a third belt of the plurality of belts that is engaged with the drive portion of the second wheel and engaged with the driven portion of the third wheel, wherein the third wheel is configured to rotate slower and with more torque than the second wheel, and wherein the third wheel is configured to propel the vehicle.

17. The transmission of claim 15, wherein the electric motor is an axial flux motor, and inner surfaces of the stator and the rotor define an interior volume in which the bevel gear is positioned.

18. The transmission of claim 17, wherein the crankshaft extends between a first end and a second end along the crank axis, and the axial flux motor has a width dimension positioned within the first and second ends along the crank axis.

19. The transmission of claim 15, wherein the bevel gear provides a gear ratio of approximately 2:1, and the bevel gear rotates about an axis that is perpendicular to the motor axis.

20. The transmission of claim 15, further comprising:
a controller in communication with the electric motor; and
a battery in communication with the controller, wherein the controller is configured to receive an input signal, and the controller is configured to cause the battery to transmit electric power to the electric motor.
